(19) United States
(12) Patent Application Publication
(10) Pub. No.: US 2026/0193472 A1
(43) Pub. Date: Jul. 9, 2026

(54) ANTICORROSION METHOD FOR WATER SYSTEM AND METAL CORROSION INHIBITOR

(71) Applicant: KURITA WATER INDUSTRIES LTD., Tokyo (JP)

(72) Inventors: Kazuhisa FUJITA, Tokyo (JP); Qian LIN, Tokyo (JP); Yutaka KAYAMORI, Tokyo (JP); Shogo KASHIWAGI, Tokyo (JP)

(73) Assignee: KURITA WATER INDUSTRIES LTD., Tokyo (JP)

(21) Appl. No.: 19/133,706

(22) PCT Filed: Nov. 9, 2023
(86) PCT No.: PCT/JP2023/040326

§ 371 Date: May 28, 2025

(30) Foreign Application Priority Data
Dec. 2, 2022 (JP) 2022-193370

(51) Int. Cl. C09D 5/08; C08F 220/06; C08K 5/5317; C09D 7/63; C09D 133/26; C23F 11/173

(52) U.S. Cl. CPC C09D 5/086; C08F 220/06; C09D 7/63; C09D 133/26; C23F 11/173; C08F 2800/10; C08K 5/5317

(57) ABSTRACT

An anticorrosion method for a water system, for suppressing corrosion of a metal in contact with the water system, including using a phosphorus compound, a film forming amine, and a copolymer of a (meth)acrylic acid monomer and a sulfonic group-containing monomer and having a weight average molecular weight of 500 to 100,000, in the water system. A metal corrosion inhibitor including a phosphorus compound, a film forming amine, and a low molecular weight polymer having a weight average molecular weight of 500 to 100,000, and an anticorrosion method for a water system, for suppressing corrosion of a metal in contact with water, including using a metal corrosion inhibitor.

### TECHNICAL FIELD

The present invention relates, for example, to an anticorrosion method for a water system, a metal corrosion inhibitor, a water treatment agent for metal anticorrosion, a water treatment agent, and an anticorrosion method for a water system including using these agents to suppress corrosion of a metal in contact with water.

### BACKGROUND ART

Metal members (for example, heat exchangers, reaction vessels, piping, and the like made of carbon steel, copper, or copper alloy etc.) installed in a water system (such as an open circulation cooling water system etc.) are subject to corrosion due to being in contact with the water in the water system, and so an anticorrosion treatment is generally performed by adding a chemical agent.

For example, technology that uses a film forming amine is being considered to suppress corrosion of heat exchangers, reaction vessels, and piping made of carbon steel in cooling water systems.

For example, Non Patent Literature 1 proposes a method using a film forming amine as another method for suppressing corrosion. The method described in Non Patent Literature 1 is mainly applied for a corrosion suppressing effect of iron-based members in boiler water systems. In Non Patent Literature 1, as the anticorrosion mechanism by the film forming amine, it is disclosed that metal corrosion is suppressed by adsorbing the film forming amine to the surface of the metal via an amino group to form a dense film of a monomolecular or multimolecular layer, thereby preventing the metal from coming into contact with the water.

For example, Patent Literature 1 proposes an anticorrosion method for suppressing corrosion of a metal member in contact with a cooling water system by making a film forming amine and an M-alkalinity component coexist in the cooling water system to form a corrosion-resistant coating on the surface of the metal member, wherein a neu-tralizing amine is used as the M-alkalinity component to adjust the M-alkalinity of the cooling water system to 90 mg/L as CaCO₃ or more during the initial treatment of forming the corrosion-resistant coating.

### CITATION LIST

### Patent Literature

PTL 1: WO 2019/078104

### Non Patent Literature

NPL 1: Corrosion Center News No. 054 (August 2010) Water Treatment Technology (1) “Corrosion/Anticorrosion in Boilers and surrounding Equipment”, Fumio Kawamura

### SUMMARY

### Technical Problem

However, conventionally, the anticorrosion strength of a film forming amine itself has been weak. Moreover, there have been cases where the corrosivity of a material during the period that the film forming amine is being used as a scale remover in an open circulation cooling water system has been of concern.

Therefore, a main object of the present invention is to provide a technology relating to anticorrosion in a water system for better suppression of corrosion of a metal in contact with water.

### Solution to Problem

As a result of intensive studies, the present inventors have discovered that by using a phosphorus compound, a film forming amine, and a polymer (preferably a (meth)acrylic acid copolymer and/or a low molecular weight polymer) in combination, corrosion of a metal in contact with water can be better suppressed. In addition, the present inventors have discovered that metal anticorrosion by a phosphorus compound can be better enhanced by using the film forming amine and the polymer in combination. That is, the present inventors completed the following invention.

The present invention provides an anticorrosion method for a water system, for suppressing corrosion of a metal in contact with the water system, comprising using a phosphorus compound, a film forming amine, and a copolymer of a (meth)acrylic acid monomer and a sulfonic group-containing monomer and having a weight average molecular weight of 500 to 100,000, at more than 5 mg/L, in the water system.

Further, the present invention provides a metal corrosion inhibitor comprising a phosphorus compound, a film forming amine, and a low molecular weight polymer having a weight average molecular weight of 500 to 100,000, wherein the polymer is contained to be used at an addition amount of more than 5 mg/L.

In addition, the present invention provides a water treatment agent for metal anticorrosion, comprising at least one of a phosphorus compound, a film forming amine, or a copolymer of a (meth)acrylic acid monomer and a sulfonic group-containing monomer and having a weight average molecular weight of 500 to 100,000, wherein, when used for metal anticorrosion in a water system, the phosphorus compound, the film forming amine, and the copolymer of a (meth)acrylic acid monomer and a sulfonic group-containing monomer are used in combination in the water system, and the copolymer is contained to be used at an addition amount of more than 5 mg/L.

Still further, the present invention provides a water treatment agent comprising a film forming amine and/or a copolymer of a (meth)acrylic acid monomer and a sulfonic group-containing monomer and having a weight average molecular weight of 500 to 100,000, wherein, when used in a water system, the water treatment agent is used by combining the film forming amine and the copolymer of a (meth)acrylic acid monomer and a sulfonic group-containing monomer to enhance metal anticorrosion by a phosphorus compound, and
the copolymer is contained to be used at an addition amount of more than 5 mg/L.

The copolymer may be a copolymer of a (meth)acrylic acid monomer and a monomer containing an amide group or a hydroxy group and a sulfonic group.

The film forming amine may be an aliphatic amine compound.

The phosphorus compound may be a phosphonic acid compound.

When the film forming amine is used, the copolymer of a (meth)acrylic acid monomer and a sulfonic group-containing monomer may be used in combination, in the water system.

The water system may be a cooling water system.

The present invention can also provide an anticorrosion method for a water system, for suppressing corrosion of a metal in contact with water, comprising using the agents described above.

### Advantageous Effects of Invention

According to the present invention, a technology relating to anticorrosion in a water system for better suppression of corrosion of a metal in contact with water can be provided. It is noted that the effects of the present invention are not necessarily limited to the effects described herein, and may be any of the effects described herein.

### BRIEF DESCRIPTION OF DRAWINGS

FIG. 1 is a schematic diagram illustrating an example of a water system used in the method of this embodiment, for example, an example of a circulation cooling water system having a cooling tower, and the present invention is not limited thereto.

FIG. 2 is a schematic diagram of the rotary corrosion testing apparatus used in the test conducted in this specification.

### DESCRIPTION OF EMBODIMENTS

Hereinafter, preferred embodiments for carrying out the present invention will be described. It is noted that the embodiment described below is an example of a representative embodiment of the present invention, and the scope of the present invention should not be narrowly interpreted to only this example. Further, in this specification, percentages are expressed in terms of mass (mass/mass %), unless otherwise specified. Further, the upper limit value (or less) and lower limit value (or more) of each numerical range can be freely combined as desired.

1. Metal Anticorrosion Method for a Water System According to this Embodiment

The present invention can provide an anticorrosion method for a water system, for suppressing corrosion of a metal in contact with the water system, including using a phosphorus compound, a film forming amine, and a polymer in the water system. The anticorrosion method for a water system may be an anticorrosion treatment method for a water system. The polymer is preferably a low molecular weight and/or (meth)acrylic acid polymer. More specifically, examples include a low molecular weight polymer, a (meth)acrylic acid polymer, and a low molecular weight (meth)acrylic acid polymer. It is preferred to select one or two or more from these. More preferably, the polymer is a copolymer of a (meth)acrylic acid monomer and a sulfonic group-containing monomer and having a weight average molecular weight of 500 to 100,000.

According to the present invention, a technology relating to anticorrosion in a water system for better suppression of corrosion of a metal in contact with water can be provided. Further, according to the present invention, by using the film forming amine and the polymer in combination, it is possible to provide a technology that can better enhance metal anticorrosion by a phosphorus compound, thereby enabling a technology for metal anticorrosion in a water system that can reduce the usage amount of the phosphorus compound or phosphorus to be provided. According to the present invention, it is possible to provide a technology that can enhance the anticorrosion strength for a metallic material used in a water system or cooling water system (preferably circulation cooling water, more preferably an open circulation cooling water system). Further, according to the present invention, it is possible to provide a technology that enhances the anticorrosion strength for a metallic material during descaling a water system, thereby enabling the life of the metallic material to be extended.

In the conventional art, film forming amines are used by being added to a water system for anticorrosion of metal members included in the water system, and for example, a corrosion inhibitor against steam such as in a boiler, or enhancing anticorrosion for a metallic material by a combination of a corrosion inhibitor for copper and acid consumption, has been proposed. Further, the use of film forming amines as on-line scale removers in open circulation cooling water systems has also attracted attention. However, the anticorrosion strength of a film forming amine itself is weak, and there have been cases where the corrosivity of a material during the period that the film forming amine is being used as a scale remover has been of concern.

On the other hand, in the present invention, when a film forming amine is used as a scale remover (preferably an on-line scale remover), further use of a low molecular weight and/or (meth)acrylic acid polymer can provide a technology that can enhance anticorrosion strength and achieve a corrosion suppressing effect on the material being descaled.

In this specification, “on-line” in “on-line scale remover” refers to carrying out scale removal by operating the water system without stopping (for example, continuously operating or circulating by a circulating water system, and the like), operations (plant operations and the like) of the water system.
In addition, in this embodiment, by operating the water system, the chemical agent to be used or water containing the chemical agent comes into contact with the members of the water system (for example, metal members, internal piping, and the like) during the period the water system is operating, and thus in addition to a corrosion-preventing effect, a scale-suppressing effect can also be exerted.

This embodiment will now be described in detail below.

In this embodiment, the anticorrosion target is a metallic material, although it is not particularly limited thereto. Examples of such a metallic material include one or two or more selected from the group consisting of carbon steel, copper, galvanized steel, zinc, aluminum, aluminum alloys, stainless steel, and the like, as well as alloys thereof. Further, among metallic materials, iron-based materials are preferred, and examples of such iron-based materials include general iron materials (for example, pure iron, carbon steel, cast iron, and the like), and more preferably, for example, carbon steel materials that are often used for carbon steel pipes (for example, STB steel pipes), and the like, for boilers and heat exchangers. In JIS G 0203, it is stated that carbon steel materials have a carbon content in the range of 0.02% by mass to approximately 2% by mass. More specifically, among carbon steels, carbon steel having a carbon content of 0.25% by mass or less is said to be low carbon steel, carbon steel having a carbon content of 0.25 to 0.6% by mass is said to be medium carbon steel, and carbon steel having a carbon content of 0.6% by mass or more is said to be high carbon steel. Since low to medium carbon steels are widely used, a carbon steel containing 0.6% by mass or less is also called ordinary steel. Further, cast iron is said to have a carbon content of more than 2% by mass. In this embodiment, among these, ordinary steel, low carbon steel, and medium carbon steel, and more preferably low carbon steel, can better exhibit the corrosion-preventing effect.

The target of the anticorrosion treatment to which this embodiment is preferably applied is preferably a metallic material that contacts water or a metal member that uses a metallic material that contacts water.

Examples of the locations or devices where the metallic material or metal member is used in a water system include various type of piping and pipes, such as water supply pipes, pumps, flow paths, heat exchangers, refrigerators, and the like, and the locations or devices may be one or two or more selected from these. More specifically, these locations or devices or metal products or parts of these locations or devices are the target of the anticorrosion treatment to which this embodiment is preferably applied.

### 1-1. Phosphorus Compound

The phosphorus compound used in this embodiment is preferably a phosphorus oxo-acid compound having at least P(═O) (—OH). Examples of preferred phosphorus compounds include phosphonic acid compounds, phosphinic acid compounds, phosphoric acid compounds, and the like, and one or two or more can be selected from these. These compounds may be in the form of a salt. The salt is not particularly limited, and examples include salts of alkali metals (for example, sodium, potassium, and the like), alkaline earth metals (for example, calcium, magnesium, and the like), and the like, and one or two or more of these can be used.

The phosphorus compound is preferably a compound that can be used in a water system (preferably a water treatment such as anticorrosion), and more preferably is a water-soluble compound. The phosphorus compound preferably has a scale inhibition effect, and is preferably a compound that can be used as a scale inhibitor for membranes. Further, the phosphorus compound is preferably a compound that traps metal ions (for example, Ca, Al, and the like), and is preferably a compound that can be used as a phosphoric acid compound scale inhibitor or a phosphonic acid compound scale inhibitor. The form of the phosphorus compound in this embodiment is not particularly limited, and may be liquid, solid, or semi-solid, with a liquid being preferred for its ease of handleability. Further, the phosphorus compound used in this embodiment may be a commercially available product or a compound obtained by a known production method. One or two or more of these can be used.

Among the phosphorus compounds, from the viewpoint of exerting a better corrosion-preventing effect, organic phosphorus compounds are preferred, and phosphonic acid compounds are more preferred. When using an organic phosphorus compound (a phosphonic acid compound is preferred), the organic phosphorus compound may be used in combination with a phosphoric acid compound.

The phosphonic acid compound is preferably a compound having at least a phosphonic acid group, and preferably an organic phosphorus compound. Examples of the phosphonic acid compound include 2-phosphonobutane-1,2,4-tricarboxylic acid (PBTC, also known as 2-phosphono-1,2,4-tricarboxybutane),

1-hydroxyethylidene-1,1-diphosphone acid (HEDP, also known as:
1-hydroxyethane-1,1-diphosphonic acid), 2-hydroxyethylidene diphosphonic acid, amino trimethylene phosphonic acid, ethylene diamine tetra(methylenephosphonic acid), diethylene triamine penta(methylenephosphonic acid), and the like, as well as salts thereof. One or two or more can be selected from among these examples. Among these, 2-phosphonobutane-1,2,4-tricarboxylic acid (PBTC) and/or 1-hydroxyethylidene-1,1-diphosphonic acid (HEDP) are preferred. One or two or more can be selected from these.

The phosphinic acid compound is a compound having at least a phosphinic acid group. Examples include, as a phosphinate, bis(poly-2-carboxyethyl)phosphinic acid, phosphinocarboxylic acid copolymers, and the like, as well as salts thereof. Among these, a phosphinocarboxylic acid salt is preferred. One or two or more can be selected from these.

One or two or more can be appropriately selected from the examples of the phosphorus compounds mentioned above.

The phosphoric acid compound is preferably a compound containing at least a phosphoric acid group, preferably a compound that can generate phosphate ions in the water of the water system, and more preferably an inorganic phosphoric acid compound. Examples of the phosphoric acid compound include phosphorus, phosphoric anhydride, phosphoric acid (also referred to as orthophosphoric acid); polymerized phosphoric acids (for example, chain polyphosphoric acids such as pyrophosphoric acid, tripolyphosphoric acid, orthopolyphosphoric acid, de-cametaphosphoric acid, and the like; and cyclic polyphosphoric acids such as hexam-etaphosphoric acid; and salts thereof). One or two or more can be selected from these. The number of phosphorus atoms in the phosphoric acid compound is not particularly limited, but is, for example, 1 to 10, and examples include orthophosphoric acid (1 phosphorus atom) and pyrophosphoric acid (2 phosphorus atoms).

The usage concentration (mg PO₄/L, hereinafter referred to as “mg/L”) when using the phosphorus compound in the water system is not particularly limited, but is preferably 0.1 to 10 mg/L, and more preferably 3 to 6 mg/L. It is preferable to add the phosphorus compound so as to obtain such a concentration. In a more preferred mode, the usage concentration (mg PO₄/L) when the phosphonic acid compound is used in the water system is preferably 0.1 to 10 mg/L, and more preferably 3 to 6 mg/L.

In addition, as the usage concentration of the above-described phosphorus compound and the like, the preferred upper limit value and the preferred lower limit value described later in “Usage amount of the phosphorus compound (preferably phosphonic acid compound) in the water system” in section “1-4.” may be appropriately adopted.

Moreover, the concentration of the phosphorus compound (mg PO₄/L) can be determined using the molybdenum blue (ascorbic acid reduction) method (JIS K 0102 46.1.1).

### 1-2. Film Forming Amine

The film forming amine used in this embodiment is not particularly limited, but is preferably an amine that can form a corrosion-resistant coating that has an effective corrosion suppressing effect on metallic materials in contact with water. As the film forming amine, a film forming amine that is normally used as a corrosion inhibitor in a water system such as a boiler water system or a cooling water system may be used, or the film forming amine may be a film forming amine that is generally used in water systems. As the film forming amine, one or two or more of aliphatic amine compounds (for example, aliphatic monoamine compounds, aliphatic diamine compounds, and the like) and the like can be used. In this specification, “aliphatic amine compound” may be expressed as “aliphatic amine.” Since film forming amines do not easily dissolve in water, the film forming amine may be used by dissolving it in an oil or by dispersing it in water as an emulsion.

In this embodiment, by using at least the film forming amine and the polymer in combination, there are the advantages that it is possible to strengthen the anticorrosion strength and it is possible to aim for a corrosion suppressing effect on the material (for example, metallic material) that is undergoing scale removal. Moreover, when the film forming amine is used as an on-line scale remover, there is the advantage that a better corrosion-preventing effect can be exerted.

The aliphatic amine compound (aliphatic amine) preferably has one or two nitrogen atoms and has the aliphatic group bonded to at least one nitrogen atom. The aliphatic amine compound (aliphatic amine) is not particularly limited, but examples include aliphatic amines, salts thereof, and derivatives thereof. One or two or more selected from these may be used. More preferable examples include aliphatic monoamine compounds, aliphatic diamine compounds, and the like, and one or two or more of compounds selected from these can be used.

The aliphatic amine compound (aliphatic amine) is preferably a long-chain aliphatic amine compound (long-chain aliphatic amine). The number of carbon atoms in the long-chain aliphatic group is not particularly limited as long as a corrosion-resistant coating can be formed, and is preferably 10 to 22, more preferably 12 to 20, and further preferably 16 to 18. When the number of carbon atoms is 10 or more, a film can be easily formed on the metal member, and the corrosion suppressing effect function can be exerted well. When the number of carbon atoms is 22 or less, handleability during chemical injection is excellent and tends to be able to be improved.

The aliphatic group constituting the aliphatic amine compound (aliphatic amine) may contain an unsaturated bond. Further, the hydrogen moiety of the amino group constituting the aliphatic amine compound may be appropriately replaced by a hydrocarbon group such as a methyl group or an ethyl group. In addition, the aliphatic amine may be a fatty acid salt (for example, a mixed amine compound and the like). In this case, examples of the fatty acid moiety constituting the fatty acid salt include one or two or more selected from the group consisting of oleic acid, lauric acid, stearic acid, and the like. When the aliphatic amine compound is a fatty acid salt, the raw material may be, for example, one or two or more selected from the group consisting of animal oils, vegetable oils, and microbial oils, with animal and vegetable oils being preferred.

Preferred specific examples of the aliphatic amine compound (aliphatic amine) include saturated aliphatic amine compounds (alkylamines), unsaturated aliphatic amine compounds (alkynylamines), mixed amine compounds (for example, coconut oil amine, hydrogenated tallow amine, and the like), alkylene oxide adducts of an aliphatic amine compound, and the like. One or two or more selected from these can be used. Examples of “alkylene oxide adducts of an aliphatic amine compound” include those obtained by addition polymerization of ethylene oxide or propylene oxide, or the like, to an aliphatic mixed amine, or the like.

The aliphatic group in the aliphatic amine compound may be either acyclic or cyclic, and more specifically it may be a chain (linear, branched) or alicyclic (non-aromatic ring). However, a chain is preferred. The aliphatic group is preferably a saturated aliphatic group, and more preferably an alkyl group or an alkylene group, which may have an appropriate substituent.

Examples of the structure of the aliphatic monoamine compound include, but are not limited to, an “aliphatic group-amino group” and the like. Examples of the aliphatic diamine compound include, but are not limited to, a compound in which at least one of the hydrogen atoms of an amino group in the compound is replaced by an aliphatic group and in which a divalent aliphatic group is present between the nitrogen atom of one amino group and the nitrogen atom of the other amino group. Examples of the aliphatic diamine compound include “amino group-divalent aliphatic group-amino group”, and it is preferred that at least one of the amino groups is an “aliphatic group-amino group”. Examples include “RR′N-divalent aliphatic group —NH₂”, such as trimethylene diamine (also referred to as “diaminopropane”). The divalent aliphatic group may be a chain (linear, branched) or alicyclic, but is preferably linear. “Amino group” refers to a monovalent functional group (—NH₂, —NHR, —NRR′) obtained by removing a hydrogen from ammonia, a primary amine, or a secondary amine. R and R′ may each be hydrogen, or one of R and R′ may be hydrogen and the other may be an alkyl group, or R and R′ may each be the same or different alkyl groups.

The divalent aliphatic group is preferably a divalent saturated or unsaturated hydrocarbon group, more preferably a divalent saturated hydrocarbon group, and further preferably a chain alkylene group having 1 to 4 carbon atoms (preferably a methylene group or an ethylene group). Examples include —(CH₂) n-, wherein n=1 to 4), as well as a diethylene group (n=2), a triethylene group (n=3), and the like.

Examples of the aliphatic amine compound (preferably long-chain aliphatic amine compound) include saturated aliphatic monoamine compounds (for example, dode-cylamine, tridecylamine, tetradecylamine, heptadecylamine, hexadecylamine, octade-cylamine, nonadecylamine, eicosylamine, docosylamine, and the like), unsaturated aliphatic monoamine compounds (for example, oleylamine, ricinoleylamine, lino-leylamine, linolenylamine, and the like), mixed monoamine compounds (for example, coconut oil amine, hydrogenated tallow amine, and the like); diamino compounds having an aliphatic group in the amino group (for example, alkylpropanediamine (the alkyl preferably has 16 to 18 carbon atoms), N,N-diethyl-1,3-propanediamine, N-oleyl-1,3-diaminopropane, N-tallow-1,3-diaminopropane, N-coco-1,3-diaminopropane, and the like); alkylene oxide adducts such as N-tallow-1,3-diaminopropane-ethylene oxide adducts, and the like. One or two or more selected from these can be used.

Among the above-described aliphatic amine compounds (aliphatic amines), preferred are aliphatic monoamine compounds and/or aliphatic diamine compounds, more preferred are aliphatic diamine compounds, and further preferred are long-chain aliphatic compounds.

The usage concentration (mg/L, hereinafter referred to as “mg/L”) when using the film forming amine (preferably an aliphatic amine compound, and more preferably an aliphatic diamine compound) in the water system is not particularly limited, but is preferably 5 to 70 mg/L, and more preferably 10 to 50 mg/L. It is preferred to add the film forming amine so as to obtain such a concentration. Further, that usage concentration may be the usage concentration when using on-line. In a more preferred mode, the usage concentration when using the aliphatic diamine compound in the water system is more preferably 5 to 70 mg/L, and further preferably 10 to 50 mg/L.

In addition, as the usage concentration when using the above-described film forming amine and the like, the preferred upper limit value and the preferred lower limit value described later in “Usage amount of the film forming amine (preferably aliphatic amine compound, more preferably aliphatic diamine compound) in the water system” in section “1-4.” may be appropriately adopted.

### 1-3. Polymer

The polymer used in this embodiment is not particularly limited, but organic polymer compounds that can be used in water systems are preferred, and low molecular weight polymers and/or water-soluble polymers are more preferred. Among the polymers used in this embodiment, (meth)acrylic acid polymers are preferred, (meth)acrylic acid polymers containing a sulfonic group in the molecule are more preferred, and (meth)acrylic acid polymers containing a sulfonic acid group in the molecule are further preferred. Among them, AA/AMPS polymers and AA/HAPS polymers are preferred. Further, the polymer used in this embodiment may be a homopolymer obtained from the same monomer, but a copolymer obtained using different monomers is preferred. As the polymer used in this embodiment, a polymer used as a scale inhibitor in cooling water systems can be preferably used. The form of the polymer salt is not particularly limited, but salts that can turn monomers and polymers into water-soluble salts are preferred. Examples include alkali metal salts of sodium, potassium, and the like, alkaline earth metal salts of calcium, magnesium, and the like, ammonium or ammonium salts of primary to tertiary amines and the like, and the like. One or two or more selected from these can be used.

Examples of the polymer used in this embodiment include homopolymers or copolymers obtained by polymerizing or copolymerizing one or two or more of monomers selected from the group consisting of: (meth)acrylic acid compounds such as (meth)acrylic acid (acrylic acid and/or methacrylic acid) and 2-hydroxyethyl methacrylate (HEMA); sulfonic group-containing monomers such as 1-propane sulfonic acid (HAPS), 2-acrylamido-2-methylpropane sulfonic acid (AMPS), styrene sulfonic acid (SS), and isoprene sulfonic acid (IPS); isobutylene (IB); maleic acid, and the like. It is noted that monomers of (meth)acrylic acid compounds other than (meth)acrylic acid may be used, for example, (meth)acrylic acid compounds having an ester, a hydroxyl group, an amino group, or the like may be used, but (meth)acrylic acid is preferred.

Among the above-described polymers, preferred is a (meth)acrylic acid polymer, and more preferred is a copolymer of a (meth)acrylic acid monomer and a sulfonic acid monomer. More preferred specific examples include homopolymers or copolymers obtained by polymerizing or copolymerizing one or two or more of monomers selected from the group consisting of: (meth)acrylic acid (preferably acrylic acid (AA)); 2-hydroxy-3-(allyloxy)-1-propane sulfonic acid (HAPS), 2-acrylamido-2-methylpropane sulfonic acid (AMPS), and the like.

The weight average molecular weight of the polymer (preferably (meth)acrylic acid polymer) is not particularly limited, but is preferably a low molecular weight. A preferred lower limit value is preferably 500 or more, more preferably 1,000 or more, more preferably 4,000 or more, and more preferably 5,000 or more. A preferred upper limit value is preferably 100,000 or less, more preferably 50,000 or less, more preferably 30,000 or less, and more preferably 20,000 or less. More specifically, a more preferred numerical range is more preferably 500 to 100,000, more preferably 1,000 to 50,000, more preferably 4,000 to 30,000, and more preferably 5,000 to 20,000.

The weight average molecular weight of the polymer in this specification can be obtained by gel permeation chromatography (GPC analysis) using a standard material, and when sodium polyacrylate is used as the standard material, the weight average molecular weight is the value based on sodium polyacrylate.

### 1-3-1. (Meth)Acrylic Acid Polymer

The polymer used in this embodiment is preferably a (meth)acrylic acid polymer, more preferably a (meth)acrylic acid copolymer. More specifically, the polymer is preferably a copolymer of a (meth)acrylic acid monomer and a sulfonic group-containing monomer, and further preferably a copolymer of a (meth)acrylic acid monomer and a monomer containing an amide group and a sulfonic group. The monomer ratio (molar ratio (mol %)) between the (meth)acrylic acid monomer and the sulfonic group-containing monomer in the (meth)acrylic acid copolymer is preferably 99 to 1:1 to 99. The (meth)acrylic acid copolymer preferably has a low molecular weight.

### < (Meth)Acrylic Acid Monomer>

Examples of the (meth)acrylic acid monomer are not particularly limited, but include (meth)acrylic acid and salts thereof, and one or two or more selected therefrom can be used. In this embodiment, “(meth)acrylic acid” means at least one selected from the group consisting of “acrylic acid” and “methacrylic acid.” Among these, acrylic acid or a salt thereof is preferred. In addition, when the (meth)acrylic acid monomer used in this embodiment contains a sulfonic group, this monomer is preferably used as a sulfonic acid monomer. The (meth)acrylic acid monomer used in this embodiment is more preferably a monomer other than a (meth)acrylic acid monomer containing a sulfonic group.

### <Sulfonic Acid Monomer>

The sulfonic acid monomer is not particularly limited, but a sulfonic group-containing monomer is preferred from the viewpoint of exerting a better corrosion-preventing effect, and a monomer in which the monomer is unsaturated monomer is more preferred. Examples of the sulfonic acid monomer include, but are not limited to, monoethylenically unsaturated sulfonic acid monomers and salts thereof and the like, among which a monoethylenically unsaturated sulfonic acid monomer is preferred.

Examples of the sulfonic acid monomer include monomers having an amide group and a sulfonic group (preferably having 6 to 9 carbon atoms), monomers containing a hydroxy group and a sulfonic group (preferably having 6 to 9 carbon atoms), a sulfonated product of an aliphatic conjugated diene (preferably having 4 to 15 carbon atoms), and salts thereof. One or two or more selected from these groups can be used. Among these, monomers having an amide group and a sulfonic group (preferably having 6 to 9 carbon atoms) and monomers containing a hydroxy group and a sulfonic group (preferably having 6 to 9 carbon atoms) are preferred. Further, the “sulfonic group” of the monomer may be a sulfonic group optionally having a substituent, for example, an alkyl sulfonic group. The number of carbon atoms in the “alkyl” of that alkyl sulfonic group is preferably 1 to 8, and a methylpropane sulfonic group (also referred to as a tert-butyl sulfonic group) is more preferred. This allows a better corrosion-preventing effect to be exerted.

Examples of the monomer having an amide group and a sulfonic group include (meth)acrylamidoalkylpropane sulfonic acids, crotonamidoalkylpropane sulfonic acids, and the like. More specifically, examples include 2-acrylamido-2-methyl propane sulfonic acid (AMPS), 3-acrylamido-3,3-dimethylpropane sulfonic acid, 2-methacrylamido-2-methylpropane sulfonic acid, 3-methacrylamido-3,3-dimethylpropane sulfonic acid, and the like, as well as salts thereof, and the like. One or two or more selected from these groups can be used.

Examples of the monomer containing a hydroxy group and a sulfonic group include 3-allyloxy-2-hydroxy-1-propane sulfonic acid (HAPS), 3-methacryloxy-2-hydroxypropane sulfonic acid, 3-allyloxy-1-hydroxypropane-2-sulfonic acid, 3-methacryloxy-1-hydroxypropane-2-sulfonic acid, and salts thereof. One or two or more selected from these groups can be used.

Examples of the sulfonated product of an aliphatic conjugated diene include a sulfonated product of 1,3-butadiene, a sulfonated product of 2,3-dimethyl-1,3-butadiene, and the like. One or two or more selected from these groups can be used.

Examples of more preferred sulfonic acid monomers include sulfonic group-containing unsaturated monomers such as (meth)acrylamidomethylpropane sulfonic acid, 3-allyloxy-2-hydroxypropane sulfonic acid, (meth)allyl sulfonic acid, vinyl sulfonic acid, styrene sulfonic acid, and 2-sulfoethyl methacrylate, and salts thereof. One or two or more selected from these groups can be used. Among these, at least one monomer selected from the group consisting of 2-acrylamido-2-methylpropane sulfonic acid (AMPS) and 3-allyloxy-2-hydroxypropane sulfonic acid (HAPS) is preferred, and AMPS and/or HAPS is more preferred. By using these, a better corrosion-preventing effect can be exerted.

### <Production Example of (Meth)Acrylic Acid Copolymer>

The (meth)acrylic acid copolymer can be produced by a known production method. Preferred copolymers are polymers obtained by copolymerizing (i) a (meth)acrylic acid monomer and (ii) one or two or more sulfonic acid monomers selected from the group consisting of monomers containing an amide group and a sulfonic group, monomers containing a hydroxy group and sulfonic group, and the like, in a predetermined mass usage ratio. It is noted that any monomer may be used within a range that does not impair the effects of the present invention.

More preferred (meth)acrylic acid copolymers are polymers obtained by copolymerizing (i) an acrylic acid monomer and (ii) at least one of sulfonic acid monomer selected from the group consisting of 2-acrylamido-2-methylpropane sulfonic acid and 3-allyloxy-2-hydroxypropane sulfonic acid, in a predetermined mass usage ratio. Examples of further preferred (meth)acrylic acid copolymers include one or two or more selected from the group consisting of copolymers of an acrylic acid monomer and 2-acrylamido-2-methylpropane sulfonic acid monomer and copolymers of an acrylic acid monomer and 3-allyloxy-2-hydroxypropane sulfonic acid monomer, and the like. In this case, a more preferred predetermined molar ratio between the (meth)acrylic acid monomer and the sulfonic acid monomer is, for example, 1 to 99:99 to 1. As this molar ratio, the molar ratio described later in <Molar ratio (mol %) in the (meth)acrylic acid copolymer>can be appropriately adopted. This enables a polymer that exerts a better corrosion-preventing effect to be obtained.

### <Molar Ratio (Mol %) Between the (Meth)Acrylic Acid Monomer and the Sulfonic Acid Monomer>

The molar ratio between the (meth)acrylic acid monomer and the sulfonic acid monomer (mol %: when the total amount of both is 100) in the copolymer of component (A) (meth)acrylic acid monomer and sulfonic acid monomer is not particularly limited, and as a preferred lower limit value of the (meth)acrylic acid monomer, a molar ratio of 10 or more is preferred, 40 or more is more preferred, 50 or more is further preferred, 60 or more is more preferred, 70 or more is more preferred, 75 or more is more preferred, and 80 or more is more preferred. Further, as a preferred upper limit value of the (meth)acrylic acid monomer, 99 or less is preferred, 98 or less is more preferred, 95 or less is further preferred, 93 or less is more preferred, and 90 or less is further preferred. As a more preferred numerical range of the molar ratio between the acrylic acid monomer and the sulfonic acid monomer, 50 to 99:50 to 1 is more preferred, 60 to 95:40 to 5 is further preferred, and 75 to 95:25 to 10 is more preferred. By setting the copolymer of component (A) to the above molar ratio, a better corrosion-preventing effect can be exerted. For this molar ratio, the respective molar ratio (%) between the (meth)acrylic acid monomer and the sulfonic acid monomer for constituting the copolymers such as AA/AMPS polymer and the AA/HAPS polymer, which are described later, may be adopted as appropriate.

As a more preferred mode of the molar ratio of the copolymer, the molar ratio (mol %) between the (meth)acrylic acid monomer in the copolymer containing a (meth)acrylic acid monomer and a sulfonic acid monomer containing an amide group and/or a hydroxyl group and the sulfonic acid monomer containing an amide group and a hydroxyl group is more preferably 60 to 95:40 to 5, and more preferably 75 to 90:25 to 10. By setting the molar ratio in this way, a better corrosion-preventing effect can be exerted. For this molar ratio, the preferred lower limit value and the preferred upper limit value described above in “Molar ratio between the (meth)acrylic acid monomer and the sulfonic acid monomer” can be appropriately adopted.

Further, as a more preferred mode of the molar ratio of the copolymer, in the case of an AA/AMPS polymer or an AA/HAPS polymer, the AA/AMPS ratio and the AA/HAPS ratio (mol %) (AA: AMPS or HAPS) is preferably (AA) 50 to 99:50 to 1, further preferably (AA) 60 to 95:40 to 5, and more preferably (AA) 75 to 90:25 to 10. By setting the molar ratio in this way, a better corrosion-preventing effect can be exerted. For this molar ratio, the preferred lower limit value and the preferred upper limit value described above in “Molar ratio between the (meth)acrylic acid monomer and the sulfonic acid monomer” can be appropriately adopted.

### <Weight Average Molecular Weight of the (Meth)Acrylic Acid Copolymer>

The weight average molecular weight of the copolymer of a (meth)acrylic acid monomer and a sulfonic acid monomer measured by GPC is not particularly limited, but as a preferred lower limit value, 500 or more is preferred, 1,000 or more is more preferred, 2,000 or more is further preferred, 3,000 or more is more preferred, 4,000 or more is further preferred, and 5,000 or more is more preferred. As a preferred upper limit value, 100,000 or less is preferred, 50,000 or less is more preferred, 40,000 or less is further preferred, 30,000 or less is more preferred, and 20,000 or less is more preferred. A preferred numerical range for the (meth)acrylic acid monomer and sulfonic acid monomer is more preferably 4,000 to 30,000, and desirably 5,000 to 20,000. In addition, as a preferred weight average molecular weight of the AA/AMPS polymer and the AA/HAPS polymer, the above-mentioned preferred lower limit value and upper limit value can be appropriately adopted, but this preferred numerical range is preferably 4,000 to 30,000, and more preferably 5,000 to 20,000. By adjusting to this weight average molecular weight, a better corrosion-preventing effect can be exerted.

The usage concentration (mg solid/L, hereinafter referred to as “mg/L”) when using the polymer (preferably a low molecular weight and/or (meth)acrylic acid polymer) in the water system is not particularly limited, but is preferably 3 to 30 mg/L, more preferably 5 to 20 mg/L, and further preferably 6 to 20 mg/L. It is preferred to add the polymer so as to obtain such a concentration. Further, in a preferred mode, the usage concentration of the (meth)acrylic acid polymer (more preferably, (meth)acrylic acid polymer containing a sulfonic group) when used in the water system is not particularly limited, but is preferably 3 to 30 mg/L, and more preferably 5 to 20 mg/L, and further preferably 6 to 20 mg/L. In addition, the usage concentration of the AA/AMPS polymer and/or AA/HAPS polymer when used in the water system is not particularly limited, but is preferably 3 to 30 mg/L, more preferably 5 to 20 mg/L, and further preferably 6 to 20 mg/L. Moreover, as the usage concentration of the polymer and the like, the preferred upper limit value and the preferred lower limit value described later in “Usage amount of the polymer (preferably a low molecular weight and/or (meth)acrylic acid polymer)” in section “1-4.” may be appropriately adopted.

### 1-4. Combined Use of the Phosphorus Compound, the Film Forming Amine, and the Polymer, and Preferred Usage Amounts and Preferred Usage Ratios and the Like of Each Component

In this embodiment, using the above-described phosphorus compound, the above-described film forming amine, and the above-described polymer in an anticorrosion method for a water system, for suppressing corrosion of a metal in contact with a water system, a better metal corrosion-preventing effect can be exerted by making those three components to be present in the water system. More preferred usage amounts and usage ratios of each component in the water system, and a content ratio, a blending ratio and the like in the chemical agent, will now be described below.

Further, in another aspect of this embodiment, by using the film forming amine and the polymer in combination in the water system, it is possible to provide a technology for enhancing metal anticorrosion by the phosphorus compound present in or used in the water system. A description will now be given of a better mass usage ratio or mass content ratio in the chemical agent.

The operating period in the water system in this embodiment is not particularly limited, but in order to better exert or maintain the corrosion-preventing effect, the operation may be carried out for a long period of time. A preferred lower limit value is, for example, 0.5 months or more, preferably 1 month or more, more preferably 2 months or more, and further preferably 3 months or more. A preferred upper limit value is not particularly limited, but is preferably 6 months or less, more preferably 5 months or less, and further preferably 4 months or less. A preferred numerical range is more preferably 2 to 4 months, during which time it is preferred to carry out the operation in such a way that the film forming amine and the polymer come into contact with the metallic material at least continuously or in a cyclical manner. Further, the operating period may be a usage period.

### <Preferred Usage Amounts of the Phosphorus Compound, the Film Forming Amine, and the Polymer>

The “usage concentration (mg/L)” in this embodiment may be “usage amount (mg/L)” or “addition amount (mg/L),” “usage amount (mg/L)” may be “usage concentration (mg/L)” or “addition amount (mg/L),” and “addition amount (mg/L)” may be “usage concentration (mg/L)” or “usage amount (mg/L).”

The usage amount (mg PO₄/L, hereinafter referred to as “mg/L”) of the phosphorus compound (preferably a phosphonic acid compound) in the water system is not particularly limited, but a preferred lower limit value is preferably 0.1 mg/L or more, more preferably 0.5 mg/L or more, further preferably 1 mg/L or more, more preferably 2 mg/L or more, and more preferably 3 mg/L or more. Further, a preferred upper limit value is not particularly limited, but from the viewpoint of a balance between reducing the usage amount of the chemical agent and exerting a corrosion-preventing effect, the usage amount is preferably 20 mg/L or less, more preferably 15 mg/L or less, further preferably 10 mg/L or less, more preferably 8 mg/L or less, and more preferably 5 mg/L or less. A preferred numerical range is more preferably 0.1 to 10 mg/L, and further preferably 3 to 6 mg/L.

As a more preferred mode, for the usage amount (mg PO₄/L) of the phosphonic acid compound in the water system, the preferred lower limit value and the preferred upper limit value of the usage amount of the phosphoric acid compound can be appropriately adopted. A more preferred numerical range is more preferably 0.1 to 10 mg/L, and further preferably 1 to 5 mg/L.

Further, as a more preferred mode of this embodiment, the phosphorus compound is preferably used continuously or discontinuously in the water system (preferably a cooling water system), and it is more preferred to add the phosphorus compound to blowdown water.

The usage amount (mg/L, hereinafter referred to as “mg/L”) of the film forming amine (preferably an aliphatic amine compound, more preferably an aliphatic diamine compound) in the water system is not particularly limited, but a preferred lower limit value is preferably 0.1 mg/L or more, more preferably 0.5 mg/L or more, further preferably 1 mg/L or more, more preferably 3 mg/L or more, more preferably 5 mg/L or more, more preferably 8 mg/L or more, and further preferably 10 mg/L or more. Further, a preferred upper limit value is not particularly limited, but from the viewpoint of a balance between reducing the usage amount of the chemical agent and exerting a corrosion-preventing effect, the usage amount is preferably 100 mg/L or less, more preferably 80 mg/L or less, further preferably 70 mg/L or less, more preferably 60 mg/L or less, and more preferably 50 mg/L or less. A preferred numerical range is more preferably 5 to 70 mg/L, and further preferably 10 to 50 mg/L.

Moreover, as a more preferred mode of this embodiment, the film forming amine is preferably used continuously or discontinuously in the water system (preferably a cooling water system), further preferably, is added continuously or discontinuously to blowdown water, and more preferably is added continuously to blowdown water in order to synergistically exert the corrosion-preventing effect of the film forming amine by using it in combination with the polymer.

The usage amount (mg solid/L, hereinafter referred to as “mg/L”) of the polymer (preferably a low molecular weight and/or (meth)acrylic acid polymer) in the water system is not particularly limited, but a preferred lower limit value is preferably 0.5 mg/L or more, more preferably 1 mg/L or more, further preferably 2 mg/L or more, more preferably 4 mg/L or more, more preferably 5 mg/L or more, more preferably more than 5 mg/L, more preferably 6 mg/L or more, more preferably 8 mg/L or more, more preferably 10 mg/L or more, more preferably 13 mg/L or more, and more preferably 15 mg/L or more. Further, a preferred upper limit value is not particularly limited, but from the viewpoint of a balance between reducing the usage amount of the chemical agent and exerting a corrosion-preventing effect, the usage amount is preferably 100 mg/L or less, more preferably 50 mg/L or less, further preferably 40 mg/L or less, more preferably 30 mg/L or less, and more preferably 20 mg/L or less. A preferred numerical range is more preferably 3 to 30 mg/L, further preferably 5 to 20 mg/L or 6 to 30 mg/L, and even more preferably 6 to 20 mg/L.

As a more preferred mode, for the usage amount (mg solid/L) of the low molecular weight and/or (meth)acrylic acid polymer in the water system, the preferred lower limit value and the preferred upper limit value of the usage amount of the polymer can be appropriately adopted. A preferred numerical range is more preferably 3 to 30 mg/L, further preferably 5 to 20 mg/L or 6 to 30 mg/L, and even more preferably 6 to 20 mg/L.

As an even more preferred mode, for the usage amount (mg solid/L) of the (meth)acrylic acid polymer containing a sulfonic acid group in the water system, the preferred lower limit value and the preferred upper limit value of the usage amount of the polymer can be appropriately adopted. A more preferred numerical range is more preferably 3 to 30 mg/L, further preferably 5 to 20 mg/L or 6 to 30 mg/L, and even more preferably 6 to 20 mg/L. In addition, as a more preferred mode, for the usage amount (mg solid/L) of AA/AMPS polymer and/or AA/HAPS polymer in the water system, the preferred lower limit value and the preferred upper limit value of the usage amount of the polymer can be appropriately adopted, and a more preferred numerical range is more preferably 3 to 30 mg/L, further preferably 5 to 20 mg/L or 6 to 30 mg/L, and even more preferably 6 to 20 mg/L.

Further, as a more preferred mode of this embodiment, the polymer is preferably used continuously or discontinuously in the water system (preferably a cooling water system), and addition to blowdown water is more preferred.

### <Preferred Usage Ratios or Blending Ratios of the Phosphorus Compound, the Film Forming Amine, and the Polymer>

The usage ratios of the film forming amine and the polymer in the water system or the blending ratio in the chemical agent are not particularly limited, but may be determined by appropriately combining the above-described usage amounts (mg/L) of each of those components in the water system. A preferred range of the usage ratios or blending ratios is preferably 5 to 70:3 to 30 or 6 to 30, and more preferably 10 to 50:5 or 6 to 20. Examples of such combinations include, but are not limited to, a combination of an aliphatic amine compound (for example, an aliphatic diamine compound or the like) and a monomer containing a low molecular weight (meth)acrylic acid monomer and a sulfonic group (for example, the above-described AA/AMPS polymer, AA/HAPS polymer or the like), and the like.

The usage ratios of the phosphorus compound and the film forming amine in the water system or the blending ratio in the chemical agent are not particularly limited, but may be determined by appropriately combining the above-described usage amounts (mg/L) of each of those components in the water system. A preferred range of the usage ratios or blending ratios is preferably to 0.1 to 10 of the phosphorus compound: 5 to 70 of the film forming amine, and more preferably 1 to 5 of the phosphorus compound: 10 to 50 of the film forming amine. Examples of such combinations include, but are not limited to, a combination of a phosphonic acid compound and an aliphatic amine compound (for example, an aliphatic diamine compound or the like), and the like.

The usage ratios of the phosphorus compound and the polymer in the water system or the blending ratio in the chemical agent are not particularly limited, but may be determined by appropriately combining the above-described usage amounts (mg/L) of each of those components in the water system. A preferred range of the usage ratios or blending ratios is preferably 0.1 to 10 of the phosphorus compound: 3 to 30 or 6 to 30 of the polymer, and more preferably 1 to 5 of the phosphorus compound: 5 or 6 to 20 of the polymer. Preferable examples of such combinations include, but are not limited to, a combination of a phosphonic acid compound and a monomer containing a low molecular weight (meth)acrylic acid monomer and a sulfonic group (for example, the above-described AA/AMPS polymer, AA/HAPS polymer or the like), and the like.

The usage ratios of the phosphorus compound, the film forming amine, and the polymer or the blending ratio in the chemical agent are not particularly limited, but may be determined by appropriately combining the above-described usage amounts (mg/L) of each of those components in the water system. A preferred range of the usage ratios or blending ratios is preferably 0.1 to 10 of the phosphorus compound: 5 to 70 of the film forming amine: 3 to 30 or 6 to 30 of the polymer, and more preferably 1 to 5 of the phosphorus compound: 10 to 50 of the film forming amine: 5 or 6 to 20 of the polymer. Preferable examples of such combinations include, but are not limited to, a combination of a phosphonic acid compound, an aliphatic amine compound (for example, an aliphatic diamine compound or the like), and a monomer containing a low molecular weight (meth)acrylic acid monomer and a sulfonic group (for example, the above-described AA/AMPS polymer, AA/HAPS polymer or the like), and the like.

### <Optional Components>

In this embodiment, in addition to the above-described components (specifically, the film forming amine, the polymer, and the phosphorus compound), optional components may be appropriately used in the water system or included in the chemical agent, within a range that does not impair the effects of the present invention. These optional components are not particularly limited, and for example one or two or more selected from the group consisting of a pH regulator, an antifoaming agent, a corrosion inhibitor other than the components described above, a scale inhibitor, a bactericide, an algaecide, and the like may be used.

In this embodiment, in addition to the combination of the film forming amine and the polymer described above, or the combination of these components with the phosphorus compound, it is preferred to also have a scale inhibitor, which is a component other than these, be present in the water system. Examples of the scale inhibitor include maleic acid polymers and salts thereof, polyaspartic acid and salts thereof, and one or two or more selected from these can be used.

Further, in this embodiment, in addition to the combination of the film forming amine and the polymer described above, or the combination of these components with the phosphorus compound, it is preferred to also have a slime control agent, which is a component other than these, be present in the water system. Examples of the slime control agent, but are not particularly limited to, hypochlorous acid and salts thereof, chlorine gas, hypobromous acid and salts thereof, stabilized chlorine, stabilized bromine, organic bactericides, and the like, and one or two or more selected from these can be used.

In this embodiment, in addition to the combination of the film forming amine and the polymer described above, or the combination of these components with the phosphorus compound, it is preferred that a corrosion inhibitor (more preferably, a metal compound for anticorrosion) other than these components be present in the water system. This metal compound for anticorrosion is a metal compound used for anticorrosion, and the metal compound is a metal compound that can easily release heavy metal ions into water. As long as the metal compound can exert this effect, the metal compound is not particularly limited.

Examples of the “corrosion inhibitor other than these components” include, but are not particularly limited to, metal compounds for anticorrosion such as zinc salts, tin salts, manganates, aluminum and aluminates; organic acid compounds, polyaspartic acid and salts thereof, polyitaconic acid and salts thereof, amino acid compounds, and the like. One or two or more selected from the group consisting of these can be used. Among these, metal compounds for anticorrosion are more preferred, and among these metal compounds for anticorrosion, zinc salts and/or tin salts are preferred, and zinc salts are more preferred. When a phosphoric acid compound is selected for the “phosphorus compound”, it is desirable that phosphoric acid compounds be excluded from the “corrosion inhibitor other than these components”, and when a phosphonic acid compound is selected, a phosphoric acid compound may be selected from the “corrosion inhibitors other than these components”.

As preferred “corrosion inhibitors other than these components” that can be further used in combination, one or two or more selected from the group consisting of phosphoric acid compounds (orthophosphoric acid, PBTC, hexane metaphosphoric acid, and the like), zinc salts (zinc chloride, zinc sulfate, and the like), corrosion inhibitors for copper (benzotriazole/tolyltriazole, and the like), which are usually used in the cooling water system, can be used.

The usage amount (mg solid/L, hereinafter referred to as “mg/L”) of the “corrosion inhibitor other than these components” is not particularly limited, but a preferred lower limit value is preferably 0.1 mg/L or more, and more preferably 0.5 mg/L or more. A preferred upper limit value is preferably 5 mg/L or less, more preferably 4 mg/L or less, further preferably 3 mg/L or less, and more preferably 2 mg/L or less. By having the component (C) corrosion inhibitor present in a preferred amount in the water system, a corrosion-preventing effect equal to or higher than the combined effect of the component (A) copolymer and the component (B) maleic acid polymer can be better obtained. As a result, in the case of obtaining a corrosion-preventing effect equal to or higher than that of the component (A) and the component (B), adding the component (C) enables the amounts of each of component (A) and component (B) to be added to be reduced more.

### 1-5. Metal Anticorrosion Method for a Water System

As described above, in the metal anticorrosion treatment method for a water system according to this embodiment, the film forming amine, the polymer, and the phosphorus compound can be used in combination, and it is preferred that these three components are present in the water system at the same time. Further, in this embodiment, each of these components may be added to the water system continuously or intermittently. In this embodiment, each of these components can be added to the water system at the same time or at separate times. The water system may include one or a plurality of chemical injection devices for adding a chemical agent to the water system. Each chemical injection device may inject an individual component, a mixture of two components and other components, or a mixture of three components, into the water system at the same time or at different times so that these three components are present in the water system at the same time. As a preferred example of this embodiment, it is preferred to have the film forming amine present in the water system as an on-line scale remover, and to adjust so that these three components are present in the water system at the same time. Further, as examples of the location where these components are mixed, this embodiment mentions a flow path (for example, a circulation waterway) or the inside of the piping of the water system, or a tank (for example, a pit or the like), such as a chemical agent storage tank or a chemical agent mixing tank, that can be included in the water system, but this embodiment is not limited to such locations. In addition, the water system may be appropriately equipped with a measurement device capable of measuring the concentration of each chemical agent (concentration of each component) in the water system, a measurement device capable of measuring the water quality of the water system, and the like. In this embodiment, these measurement results may be transmitted to a control unit or the like, and the control unit or the like may control or manage the method of this embodiment or the steps or operations thereof.

As described above, it is preferred that, in the metal anticorrosion method for a water system according to this embodiment, the combination of the film forming amine and the polymer, or the combination of the film forming amine, the polymer, and the phosphorus compound be present in the water system in a predetermined mass usage ratio or mass content ratio.

In this embodiment, the combination of the film forming amine and the polymer, or the combination of the film forming amine, the polymer, and the phosphorus compound can be added to the water system as a one-component chemical agent or as a multi-component chemical agent (for example a combination product).

As another aspect of this embodiment, an anticorrosion method for a water system can be provided by adding a water treatment agent containing at least one of the phosphorus compound, the film forming amine, and the polymer to the water system to make the phosphorus compound, the film forming amine, and the polymer be present in the water system.

In addition, as a combined use of the film forming amine and the polymer in the water system, or a combined use of the film forming amine, the polymer, and the phosphorus compound in the water system, these three components can be added at the same time or at different times so that these three components are present in the water system. The addition of these three components may be carried out continuously or intermittently.

In this embodiment, as a more preferred mode, a metal anticorrosion treatment method for a water system can be provided that uses the following (i) metal anticorrosion treatment agent, (ii) water treatment agent, or (iii) water treatment agent for metal anticorrosion or a combination product for a water treatment agent. In this specification, a combination product may be a product set or a kit product.
(i) A metal corrosion inhibitor including a phosphorus compound, a film forming amine, and a polymer.
(ii) A water treatment agent containing a film forming amine and/or a polymer, wherein, when used in a water system, the water treatment agent is used by combining the film forming amine and the polymer to enhance metal anticorrosion by the phosphorus compound.
(iii) A water treatment agent for metal anticorrosion containing at least one of a phosphorus compound, a film forming amine, and a polymer, wherein, when used for metal anticorrosion in a water system, the water treatment agent is to be used by combining the phosphorus compound, the film forming amine, and the polymer in the water system. The water treatment agent may be a combination product for a water treatment agent consisting of at least one, two, or three selected from the group consisting of a first water treatment agent containing the phosphorus compound, a second water treatment agent containing the film forming amine, and a third water treatment agent containing the polymer.
   As a more preferred aspect of the present embodiment, when used in a water system, the agents such as the metal corrosion inhibitor, the water treatment agent, and the third water treatment agent described above are preferably contained or configured such that the polymer (preferably, the copolymer of a (meth)acrylic acid monomer and a sulfonic group-containing monomer) is at an addition amount of 6 mg/L or more.

The water system to which this embodiment is applied is not particularly limited, and examples include a cooling water system, an RO water system, a pulp and paper process water system, a scrubber water system, and the like. In this embodiment, a sufficient corrosion-preventing effect is exerted as long as the water quality is that of a general water system (preferably, a cooling water system).

Regarding the water quality conditions of the water system, acid consumption (pH 8.3) is not particularly limited, and from the viewpoint of a better corrosion-preventing effect, a preferred upper limit value is preferably 1000 mg CaCO₃/L or less, more preferably 500 mg CaCO₃/L or less, and further preferably 300 mg CaCO₃/L or less, and a preferred lower limit value is preferably 10 mg CaCO₃/L or more, more preferably 25 mg CaCO₃/L or more, more preferably 50 mg CaCO₃/L or more, and more preferably 50, 75 or 100 mg CaCO₃/L or more. A preferred numerical range is more preferably 25 to 500 mg CaCO₃/L, and further preferably 100 to 300 mg CaCO₃/L. The acid consumption (pH 8.3) can be determined according to JIS K0101 Industrial Water Test Method. The acid consumption is expressed by converting the amount of alkaline components (hydrogen carbonate, carbonate, hydroxide, and the like) contained in water into the equivalent concentration of calcium carbonate (unit: mg CaCO₃/L).

Regarding the water quality conditions of the water system, calcium hardness is not particularly limited, and from the viewpoint of a better corrosion-preventing effect, although a preferred upper limit value is not particularly limited, it is, for example, 1000 mg CaCO₃/L or less, more preferably 500 mg CaCO₃/L or less, and more preferably 300 mg CaCO₃/L or less, and a preferred lower limit value is preferably 5 mg CaCO₃/L or more, further preferably 10 mg CaCO₃/L or more, more preferably 25 mg CaCO₃/L or more, and more preferably 50, 75 or 100 mg CaCO₃/L or more. A preferred numerical range is preferably 25 to 300 mg CaCO₃/L. The calcium hardness can be determined according to JIS K0101 Industrial Water Test Method.

Regarding the water quality conditions of the water system, the pH of the water system is not particularly limited, but from the viewpoint of a better corrosion-preventing effect, it is preferably 6 to 11, more preferably 6.5 to 10, and further preferably 7 to 9. Further, the water temperature of the water system is not particularly limited, but from the viewpoint of a better corrosion-preventing effect, it is preferably 0 to 100° C., more preferably 5 to 80° C., and further preferably 10 to 60° C.

As a preferred mode of this embodiment, it is preferred to apply to a water system in which metallic materials that are easily corroded by water are used in various locations (for example, heat exchanger, piping, and the like), more preferably to a cooling water system, and further preferably to a circulation cooling water system. According to this embodiment, the corrosion-preventing effect of the anticorrosion treatment method of the present invention is sufficiently exerted by the more preferred applications.

The method of this embodiment can also be realized by a control unit including a CPU and the like in a device (for example computer, PLC, server, cloud service, and the like) for managing the metal anticorrosion treatment described above or the cooling water system described later. Further, the method of this embodiment can also be stored as a program in a hardware resource including a recording medium (non-volatile memory (USB memory, and the like), SSD, HDD, CD, DVD, Blu-ray D, and the like), and realized by the control unit. This recording medium is preferably a computer-readable recording medium. It is also possible to provide a device including the control unit or a system such as a metal anticorrosion treatment system in which the control unit controls the addition of a chemical agent to the water system. In addition, as constituent elements of the computer, the management device has at least a CPU, and may also include an input unit such as a keyboard, a communication unit such as a network, a display unit such as a display, a storage unit such as an HDD, ROM, RAM, and the like, and one or two or more can be selected from these. Among these, it is preferred to include a RAM, a storage unit, a display unit, and an input unit. Each of the selected constituent elements are connected, for example, by a bus as a data transmission path.

### <Cooling Water System>

The cooling water system applied to this embodiment is not particularly limited, but is preferably a system through which cooling water used for operating a heat exchanger and the like in air conditioning equipment of a building, a regional facility, and the like, or in a manufacturing plant and the like is passed. The cooling water system may be a transient mode type, an open circulation type, or a closed circulation type.

In this embodiment, when applied to a circulation cooling water system, an excellent corrosion-preventing effect can be exerted in the circulation cooling water system.

The circulation cooling water system is not particularly limited, but is preferably a water system including in the system a cooling tower installed in air conditioning equipment, a petrochemical refinery, a general factory and the like in the system, for example. It is preferred that the circulation cooling water system is configured to in-directly cool the heat source generating heat in such air conditioners, general factories, and the like, and the circulation cooling water system may be a general water system configured to include a heat exchanger, a circulation waterway, and a cooling tower.

The type of the circulation cooling water system is not particularly limited, but the system may be either an open circulation cooling water system or a closed circulation cooling water system. As the open circulation cooling water system, a configuration that allows the cooling water to circulate in an open manner is preferred. As the closed circulation cooling water system, a configuration that allows cooling water to circulate in a closed manner is preferred.

Further, the metal anticorrosion treatment method for a cooling water system according to this embodiment (more specifically, a metal anticorrosion treatment method for a metal member in a cooling water system) preferably includes at least process of adding each of the film forming amine, the polymer, and the phosphorus compound in the cooling water system, and bringing those components into contact with the metal member. At this time, the film forming amine and the polymer, or the film forming amine, the polymer, and the phosphorus compound, may be added as a metal anticorrosion treatment agent, which is a one-component chemical agent, or added as metal anticorrosion treatment agent combination product, which is a multi-component chemical agent. The film forming amine, the polymer, and the phosphorus compound may each be added to the cooling water system at the same time or at different times, and it is preferred to add so that these three components are present together in the water system. The period during which these three components are present together in the water system is not particularly limited, and may be either continuous or intermittent. For example, the phosphorus compound, the polymer (first polymer), and the film forming amine may be added in this order to the cooling water system. Further, after these are mixed, the polymer (second polymer) may be further added. The first polymer and the second polymer may be the same or different polymers, the usage amount of the second polymer is preferably 0.5 to 2 times or more that of the first polymer, more preferably about 1.5 to 2.5 times. When the first and second polymers are the same polymer, the total amount used of the first and second polymers may be the total amount used or the total amount added.

Further, the location where the chemical agent is added is not particularly limited, and may be any location in the cooling water system. Examples include an air blowing means, a water sprinkling means, a pit, a makeup water supply means, a chemical agent injection means, a circulation waterway, a transfer pump, a heat exchanger, and the like. Preferably, the location is the makeup water supply means, chemical agent injection means, circulation waterway, transfer pump, or the like, and the addition can be carried out at one or two or more locations selected from among these. By adding these three components so as to be present anywhere in the water system, a better corrosion-preventing effect on metallic materials that are in contact with water downstream therefrom can be obtained. In addition, when all or part of the water system circulates, as a result of the water system circulating, these three components are mixed, whereby a better corrosion-preventing effect on the metallic materials in contact with the water of the water system can be obtained.

As described above, according to the metal anticorrosion treatment method of this embodiment, an excellent corrosion-preventing effect can be imparted to a metal member in contact with water.

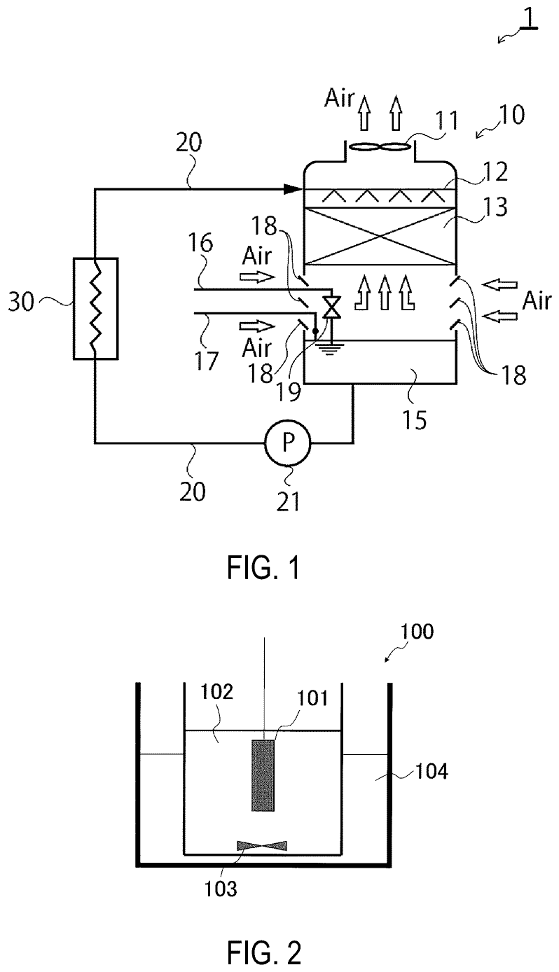

A metal anticorrosion treatment method for an open circulation cooling water system 1, which is an example of this embodiment, will be described with reference to FIG. 1, but this embodiment is not limited thereto.

In the open circulation cooling water system 1, water containing the film forming amine, the polymer, and the phosphorus compound is transferred from a pit 15 by a transfer pump 21 to a heat exchanger 30 through a circulation waterway 20, and then passes through the heat exchanger 30 and is returned to an open cooling tower 10 by a circulation waterway 20. In the cooling tower 10, the water containing these components passes through a water spraying means 12 and a filler area 13, is stored in the pit 15, and is again transferred to the circulation waterway 20 by the pump 21. With this embodiment, a corrosion-preventing effect can be maintained in the cooling water system during this circulation. As a result of this circulation, the film forming amine and the polymer, or the film forming amine, the polymer, and the phosphorus compound, present in the water in the water system can contact a metal member, and a corrosion-preventing effect on the metal member can be exerted. It is preferred that the film forming amine, the polymer, and the phosphorus compound are added to the water system using a chemical injection device that is capable of adding each component or a mixture of two or three of these components so that the three components are present together in the water system. Further, the amount of each component to be added may be adjusted so that each component is in the respective predetermined concentration range in the water system.

The film forming amine and the polymer, or the film forming amine, the polymer, and the phosphorus compound are transferred to the pit 15 by one or a plurality of chemical agent injection means 17 at the same time or at different times. These components may be mixed in the piping at the time of transfer, or may be mixed in the pit 15. Further, one or a plurality of the chemical agent injection means 17 may be provided. For example, a plurality of separate chemical agent injection means may be provided for each of the film forming amine, the polymer, and the phosphorus compound, respectively, or one chemical agent injection means may be provided for adding a one-component chemical agent containing these to the water system or for mixing these components. A make-up water supply means 16 supplies water to the pit 15 as required to make for any water shortage caused by evaporation and the like, and the flow path for supplying this make-up water to the pit 15 may be configured so that one or a plurality of chemical agents from the chemical agent injection means 17 can be added. Air for cooling passes through 13 and 12 from a louver 18 and is discharged from 11 by outside air discharged by the blowing means 11.

In the description of the example of the metal anticorrosion treatment method and the like for a water system according to this embodiment, description of the various technical features, various configurations, various definitions, various terms, various treatment methods, various means, and the like of the phosphorus compound, the film forming amine, the polymer, their usage concentration and usage ratio, metal anticorrosion treatment for the water system, metal anticorrosion treatment management in the water system, metal anticorrosion system for a water system, metal anticorrosion treatment method for a water system, and the like, which are the same as or overlap the following details (for example, “2.” to “3.” and the like) have been omitted as appropriate. However, the descriptions in “1.” to “3.” and the like may be applied to any of the embodiments, and can be appropriately adopted in each embodiment.

2. Metal Corrosion Inhibitor and the Like According to this Embodiment

In the description of the examples of metal corrosion inhibitor, water treatment agent, combination product for a water treatment agent, and the like according to the present invention, description of the various technical features, various configurations, various definitions, various terms, various treatment methods, various means, and the like of the phosphorus compound, the film forming amine, the polymer, their usage concentration and usage ratio, metal anticorrosion treatment for the water system, metal anticorrosion treatment management in the water system, metal anticorrosion system for a water system, metal anticorrosion treatment method for a water system, and the like, which are the same as or overlap the above details (for example, “1.”) and the following details (for example, “3.” and the like) have been omitted as appropriate. However, the descriptions in “1.” to “3.” and the like may be applied to any of the embodiments, and can be appropriately adopted in each embodiment.

By using the phosphorus compound, the film forming amine, and the polymer in a water system, an extremely excellent anticorrosion action can be exerted. That is, the combination of the phosphorus compound, the film forming amine, and the polymer may be included as an active substance of, for example, a metal corrosion inhibitor, water treatment agent, or chemical agent for a water system in a composition for anticorrosion in a water system, or used in such a composition, and the like. In this embodiment, the composition may be an agent, and the agent may be a composition. A composition or an agent is preferred in which the components of the phosphorus compound, the film forming amine, and the polymer used in the present embodiment are configured such that the addition amounts to the water system are each not less than a predetermined amount, or alternatively, a composition or an agent is preferably used such that the addition amounts to the water system are not less than a predetermined amount.

Further, the phosphorus compound, the film forming amine, the polymer, or a mixture thereof can be used to produce the metal corrosion inhibitor for a water system of this embodiment.

This embodiment can also provide the phosphorus compound, the film forming amine, and the polymer, or a mixture or the use thereof, for metal anticorrosion and the like in a water system. Moreover, this embodiment can also provide the phosphorus compound, the film forming amine, the polymer, or a mixture thereof, which is used for metal anticorrosion and the like in a water system.

This embodiment can also provide a metal anticorrosion method for a water system and a metal anticorrosion treatment method for a water system that use the phosphorus compound, the film forming amine, the polymer, or a mixture thereof, or a metal corrosion inhibitor, water treatment agent, combination product for a water treatment agent, and the like for a water system.

In addition, as another aspect of this embodiment, a metal corrosion inhibitor can be provided that includes a phosphorus compound, a film forming amine, and a polymer.

Further, as another aspect of this embodiment, a phosphorus compound, a film forming amine, and a polymer, or their use, or a composition including these three components, or use of such a composition, for use in metal anticorrosion or as a metal corrosion inhibitor, can be provided.

In addition, as another aspect of this embodiment, a phosphorus compound, a film forming amine, and a polymer, or their use, or a composition including these three components, or use of such a composition, for producing or for use in producing a metal corrosion inhibitor, can be provided.

As another aspect of this embodiment, a water treatment agent for metal anticorrosion containing at least one of a phosphorus compound, a film forming amine, and a polymer can be provided, wherein, when used for metal anticorrosion in a water system, the water treatment agent is to be used by combining the phosphorus compound, the film forming amine, and the polymer in the water system. The water treatment agent may be a combination product for a water treatment agent consisting of at least one, two, or three selected from the group consisting of a first water treatment agent containing the phosphorus compound, a second water treatment agent containing the film forming amine, and a third water treatment agent containing the polymer.

As another aspect of this embodiment, provided is a water treatment agent containing a film forming amine and/or a polymer, wherein, when used in a water system, the water treatment agent is used by combining the film forming amine and the polymer to enhance metal anticorrosion by a phosphorus compound.

Further, as another aspect of this embodiment, a phosphorus compound, a film forming amine, and a polymer, or use of these, for producing the agent, use in producing the agent, or use of the agent, can be provided.

In addition, as another aspect of this embodiment, an anticorrosion method for a water system, for suppressing corrosion of a metal in contact with water, including using the agent, can be provided.

The polymer is preferably a low molecular weight polymer, and is more preferably of low molecular weight, having a weight average molecular weight of 500 to 100,000. The polymer is preferably a water-soluble organic polymer, more preferably a copolymer, more preferably a copolymer of (meth)acrylic acid monomer and a sulfonic group-containing monomer, and further preferably a copolymer of (a) a (meth)acrylic acid monomer and (b) a monomer containing (i) an amide group and a sulfonic group or (ii) a hydroxyl group and a sulfonic group. A composition containing the polymer such that the addition amount to the water system is 6 mg/L or more is preferred, or the polymer is preferably used at an addition amount of 6 mg/L or more to the water system.

The polymer is preferably a (meth)acrylic acid polymer containing a sulfonic group, and the molar ratio between the (meth)acrylic acid monomer and the sulfonic acid monomer in the polymer is preferably 60 to 95:40 to 5. Among the (meth)acrylic acid polymers, an AA/AMPS polymer and/or an AA/HAPS polymer are preferred.

The phosphorus compound is preferably a phosphonic acid compound. The film forming amine is preferably a long-chain aliphatic amine compound, and among these, a long-chain aliphatic diamine compound is preferred.

The usage ratio between the film forming amine and the polymer in the water system or the blending ratio in the chemical agent is preferably 5 to 70:3 to 30.

Further, the usage ratio between the phosphorus compound and the film forming amine in the water system or the blending ratio in the chemical agent is preferably 0.1 to 10 of the phosphorus compound: 5 to 70 of the film forming amine.

In addition, the usage ratio between the phosphorus compound and the polymer in the water system or the blending ratio in the chemical agent is preferably 0.1 to 10 of the phosphorus compound: 3 to 30 or 6 to 30 of the polymer.

The usage ratio among the phosphorus compound, the film forming amine, and the polymer or the blending ratio in the chemical agent is preferably 0.1 to 10 of the phosphorus compound: 5 to 70 of the film forming amine: 3 to 30 or 6 to 30 of the polymer.

3. The technology of the present invention can also employ the following technical features, configurations, and other aspects.
<1> An anticorrosion method for a water system, for suppressing corrosion of a metal in contact with the water system, comprising using a phosphorus compound, a film forming amine, and a copolymer of a (meth)acrylic acid monomer and a sulfonic group-containing monomer, in the water system. The molecular weight of the copolymer is preferably a weight average molecular weight of 500 to 100,000. The monomer ratio in the copolymer between the (meth)acrylic acid monomer and the sulfonic group-containing monomer is preferably 60 to 95:40 to 5. Preferably, the amount of the copolymer of the (meth)acrylic acid monomer and the sulfonic group-containing monomer used is more than 5 mg/L.
<2> The method according to the above <1>, wherein the copolymer is a copolymer obtained from (a) a (meth)acrylic acid monomer and (b) (i) a monomer containing an amide group and a sulfonic group and/or (ii) a monomer containing a hydroxy group and a sulfonic group. The monomer ratio in the copolymer between the (meth)acrylic acid monomer and the monomer containing an amide group and a sulfonic group is preferably 60 to 95:40 to 5.
<3> The method according to the above <1> or <2>, wherein the film forming amine is an aliphatic amine compound. This aliphatic amine compound is preferably a long-chain aliphatic amine compound. The aliphatic amine compound is preferably an aliphatic monoamine compound and/or an aliphatic diamine compound, and more preferably an aliphatic diamine compound.
<4> The method according to any one of the above <1> to <3>, wherein the phosphorus compound is a phosphoric acid compound and/or a phosphonic acid compound, and more preferably a phosphonic acid compound. A mixture further including a corrosion inhibitor other than the phosphorus compound (for example, a zinc salt and/or a copper corrosion inhibitor) may also be used for the phosphorus compound.
<5> The method according to any one of the above <1> to <4>, wherein, when the film forming amine is used, the copolymer of a (meth)acrylic acid monomer and a sulfonic group-containing monomer is used in combination, in the water system.
<6> The method according to any one of the above <1> to <5>, wherein the water system is a cooling water system. The cooling water system is preferably an open circulation type or a closed circulation type, and more preferably an open circulation type cooling water system.
<7> A metal corrosion inhibitor comprising a phosphorus compound, a film forming amine, and a polymer. The polymer is preferably a low molecular weight polymer, and is more preferably of low molecular weight, having a weight average molecular weight of 500 to 100,000. Further, the polymer is preferably a water-soluble organic polymer, and more preferably a copolymer of a (meth)acrylic acid monomer and a sulfonic group-containing monomer. The copolymer according to any one of the above <1> to
<6> is preferably used as the polymer. The phosphorus compound and/or the film forming amine are preferably the compounds according to the above <3> and/or <4>. The metal corrosion inhibitor is preferably configured such that the polymer can be used at an addition amount of more than 5 mg/L, or the metal corrosion inhibitor is preferably used such that the addition amount of the polymer is more than 5 mg/L.
<8> A phosphorus compound, a film forming amine, and a polymer, or their use, or a composition including these three components, or use of such a composition, for use in metal anticorrosion or as a metal corrosion inhibitor. The polymer is preferably the polymer according to the above <7> or the copolymer according to any one of the above <1> to <6>. The phosphorus compound and/or the film forming amine are preferably the compounds according to the above <3> and/or <4>. The polymer is preferably used at more than 5 mg/L to the water system, or the composition is preferably configured such that the composition can be used at an addition amount of the polymer of more than 5 mg/L.
<9> A phosphorus compound, a film forming amine, and a polymer or use of one, two, or three of these, or a composition including these three components, or use of such a composition, for producing or for use in producing a metal corrosion inhibitor and the like, in the production of a metal corrosion inhibitor and the like. The polymer is preferably the polymer according to the above <7> or the copolymer according to any one of the above <1> to <6>. The phosphorus compound and/or the film forming amine are preferably the compounds according to the above <3> and/or <4>. The polymer is preferably used at more than 5 mg/L to the water system, or the composition is preferably configured such that the composition can be used at an addition amount of the polymer of more than 5 mg/L.
<10> A water treatment agent for metal anticorrosion, comprising at least one of a phosphorus compound, a film forming amine, and a polymer, wherein, when used for metal anticorrosion in a water system, the water treatment agent is to be used, or is for using, by combining the phosphorus compound, the film forming amine, and the polymer in the water system. The water treatment agent may be a combination product for a water treatment agent consisting of at least one, two, or three selected from the group consisting of a first water treatment agent containing the phosphorus compound, a second water treatment agent containing the film forming amine, and a third water treatment agent containing the polymer. The polymer is preferably the polymer according to the above <7> or the copolymer according to any one of the above <1> to <6>. The phosphorus compound and/or the film forming amine are preferably the compounds according to the above <3> and/or <4>. The polymer is preferably used at more than 5 mg/L to the water system, or the water treatment agent is preferably configured such that the water treatment agent can be used at an addition amount of the polymer of more than 5 mg/L.
<11> A water treatment agent comprising a film forming amine and/or a polymer, wherein when used in a water system, the water treatment agent is used by combining the film forming amine and the polymer to enhance metal anticorrosion by a phosphorus compound. The polymer is preferably the polymer according to the above <7> or the copolymer according to any one of the above <1> to <6>. The phosphorus compound and/or the film forming amine are preferably the compounds according to the above <3> and/or <4>.
<12> A phosphorus compound, a film forming amine, and a polymer, or use of these, for producing, for use in producing, or for use of the agent according to any one of the above [7] to [11].
<13> An anticorrosion method for a water system, for suppressing corrosion of a metal in contact with water, a method for enhancing metal anticorrosion by a phosphorus compound, or a method for reducing a usage amount of phosphorus in a water system, comprising using the components or agent according to the above <7> to <12>.

### EXAMPLES

Embodiments and the like of the present invention will now be described with reference to the following Examples and Comparative Examples and the like. However, it should be noted that the Examples described below are merely an example of a representative Examples of the present invention, and the scope of the present invention should not be narrowly interpreted to only these Examples.

### Test Example 1

### <Experimental Conditions>

Pure water was charged into in a 1 L glass beaker, and a sodium bicarbonate solution and a calcium chloride solution were added to adjust the pH to 8.4, acid consumption to 150 mg CaCO₃/L, and calcium hardness to 150 mg CaCO₃/L.

As a corrosion inhibitor, 4 mg PO₄/L of HEDP (hydroxyethylidene diphosphonic acid), and as a scale inhibitor, 5 mg solid/L of AA/AMPS polymer (monomer ratio (mol % ratio) 80:20, average weight molecular weight 20,000) were added. 50 mg/L of a film forming amine (alkylpropanediamine (alkyl having 16 to 18 carbon atoms)) was added, and then 10 mg solid/L of various polymers were added.

Tables 1 to 3 show Test Example 1 (Reference Examples 1-1 to 1-6 and Examples 1-7 to 1-10) and Test Example 2 (Reference Example 2-1 and Examples 2-2 to 2-4), and Test Example 3 (Reference Examples 3-1 to 3-3 and Examples 3-4 to 3-5) of combinations of each of the phosphorus compound, film forming amine, and polymer components.

For the Reference Examples, experiments were also carried out without adding HEDP and without adding the film forming amine.

As shown in Tables 1 and 2, the polymers used were AA/AMPS polymer, AA/HAPS polymer, and polymaleic acid polymer, having average weight molecular weights of 400 to 110,000. The molecular weight of the polymer is the average weight molecular weight, and was a value determined by GPC analysis (standard material PAANA, sodium polyacrylate, manufactured by PSS).

### <Corrosion Rate Test (Mg/Dm²/Day)>

A test piece 101, which was a SPCC (15 mm′30 mm) test piece, was immersed in a test water 102, and a test was conducted at a water temperature of 40° C. for three days at 150 rpm using a rotary corrosion testing apparatus 100 (FIG. 2) equipped with a temperature control device 104 that heats and cools the test water 102 together with a stirring device 103 that stirs the test water with a stirrer. The material of the SPCC (steel plate cold commercial: a type of cold rolled steel plate) is a low carbon steel with a carbon content of 0.15% or less.

After the test was completed, the test piece was pulled out, corrosion was removed with hydrochloric acid, and the corrosion weight was measured. The corrosion rate (mg/dm²/day) was calculated based on the corrosion weight.

Further, in order to verify the effects of different corrosion inhibitors used, an evaluation was also conducted using PBTC (4 mg PO₄/L) instead of HEDP (4 mg PO₄/L).

TABLE 1
Measurement results of corrosion rate depending on polymer addition

| | | | Film forming | | Monomer | Molecular | Corrosion rate |
|---|---|---|---|---|---|---|---|
| | No | HEDP | amine | Polymer | ratio | weight | (mg/dm2/day) |
| Reference | (1) | no | yes | no | — | — | 90.3 |
| Example 1 | (2) | no | yes | AA/AMPS | 90:10 | 6,500 | 73.4 |
| | (3) | no | yes | AA/HAPS | 80:20 | 12,000 | 113.3 |
| | (4) | yes | no | no | — | — | 22.8 |
| | (5) | yes | yes | no | — | — | 17.8 |
| | (6) | yes | yes | PMA | — | 400 | 51.2 |
| Example 1 | (7) | yes | yes | AA/AMPS | 90:10 | 6,500 | 2.2 |
| | (8) | yes | yes | AA/AMPS | 80:20 | 20,000 | 7.6 |
| | (9) | yes | yes | AA/HAPS | 80:20 | 5,500 | 4.7 |
| | (10) | yes | yes | AA/HAPS | 80:20 | 12,000 | 5.1 |

TABLE 2
Influence of Polymer Molecular Weight

| | | | Film forming | | Monomer | Molecular | Corrosion rate |
|---|---|---|---|---|---|---|---|
| | No | HEDP | amine | Polymer | ratio | weight | (mg/dm2/day) |
| Reference | (1) | yes | yes | AA/AMPS | 80:20 | 110,000 | 51.2 |
| Example 2 | | | | | | | |
| Example 2 | (2) | | | | | 20,000 | 7.6 |
| | (3) | | | | | 9,000 | 7.4 |
| | (4) | | | | | 4,000 | 13.8 |

TABLE 3
Influence of Phosphoric Acid Species

| | | | Film forming | | Monomer | Molecular | Corrosion rate |
|---|---|---|---|---|---|---|---|
| | No | PBTC | amine | Polymer | ratio | weight | (mg/dm2/day) |
| Reference | (1) | yes | no | no | — | — | 120.6 |
| Example 3 | (2) | yes | yes | no | — | — | 48.4 |
| | (3) | yes | yes | PMA | — | 400 | 34.1 |
| Example 3 | (4) | yes | yes | AA/AMPS | 90:10 | 6,500 | 3.5 |
| | (5) | yes | yes | AA/AMPS | 80:20 | 20,000 | 1.8 |

### <Results/Discussion>

Table 1 and 2 show the results of using HEDP as a corrosion inhibitor, and Table 3 shows the results of using PBTC. It was confirmed that regardless of the type of corrosion inhibitor, using AA/AMPS or AA/HAPS with a molecular weight of 4,000 to 20,000 significantly increases the corrosion-preventing effect and leads to an extension in the life of the metal during film forming amine addition. Further, from the trend in the corrosion rate, it is considered that the AA/AMPS polymer and the AA/HAPS polymer have an AA/AMPS ratio and an AA/HAPS ratio (mol %) of preferably 1 to 95:99 to 5, more preferably 60 to 95:40 to 5, and further preferably 75 to 90:25 to 10. As a result, it was confirmed that by having the three components of a film forming amine, a low molecular weight (meth)acrylic acid polymer containing a sulfur atom, and a phosphonic acid compound present in the water system, there is a significant increase in the corrosion-preventing effect on metallic materials that are contact with water. Further, it was confirmed that by using a film forming amine and a low molecular weight (meth)acrylic acid polymer containing a sulfur atom in combination, there is a synergistic effect on the corrosion suppressing effect on metallic materials in contact with water. Further, it is preferable that the polymer is used in an amount of more than 5 mg/L in a water system.

In this specification, numerals, letters of the alphabet and the like, such as “first, second, third . . . ”, “A, B, C . . . “, and “primary, secondary, tertiary . . . ”, are added to the description for convenience. However, the present invention should not be interpreted in a narrow sense, such as a sequence order, by the use of these, and the sequence order may be freely changed. A combination product may be a combination use. Further, in this specification, for example, “do (ing),” such as those in “managing”, may be used in regard to a method, process, means, or step or the like. These terms may be replaced as appropriate, for example, “step” may be replaced with the relevant form of the verb, method, process, means, or the like, “process” may be replaced with the relevant form of the verb, method, step, means or the like, “means” may be replaced with the relevant form of the verb, method, process, step, or the like. Further, in this specification, “system” may be a mechanism, a device, a means, or a unit, “mechanism” may be a system, a device, a means, or a unit, “device” may be a system, a mechanism, a means, or a unit, “means” may be a mechanism, a system, a device, or a unit, and “unit” may be a mechanism, a means, a device, or a system, or a mechanism, means, or device included therein.

### REFERENCE SIGNS LIST

1 open circulation cooling water system
10 open cooling tower
11 air blowing means
12 water spraying means
13 filler area
14 space
15 pit
16 makeup water supply means
17 chemical agent injection means
18 louver
20 circulation waterway
21 transfer pump
30 heat exchanger

To the claims:

1. An anticorrosion method for a water system, for suppressing corrosion of a metal in contact with the water system, comprising
using a phosphorus compound, a film forming amine, and a copolymer of a (meth)acrylic acid monomer and a sulfonic group-containing monomer and having a weight average molecular weight of 500 to 100,000, at more than 5 mg/L, in the water system.

2. The method according to claim 1, wherein the copolymer is a copolymer of a (meth)acrylic acid monomer and a monomer containing an amide group and a sulfonic group or a hydroxy group and a sulfonic group.

3. The method according to claim 1, wherein the film forming amine is an aliphatic amine compound.

4. The method according to claim 1, wherein the phosphorus compound is a phosphonic acid compound.

5. The method according to claim 1, wherein, when the film forming amine is used, the copolymer of a (meth)acrylic acid monomer and a sulfonic group-containing monomer is used in combination, to enhance the metal anticorrosion by the phosphorus compound, in the water system.

6. The method according to claim 1 wherein the water system is a cooling water system.

7. A metal corrosion inhibitor, comprising a phosphorus compound, a film forming amine, and a low molecular weight polymer having a weight average molecular weight of 500 to 100,000
wherein the polymer is contained to be used at an addition amount of more than 5 mg/L.

8. (canceled)

9. (canceled)

10. An anticorrosion method for a water system, for suppressing corrosion of a metal in contact with water, comprising using the metal corrosion inhibitor according to claim 7.

11. The method according to claim 1, wherein the film forming amine is a long-chain aliphatic amine compound.

12. The method according to claim 11, wherein the phosphorus compound is a phosphonic acid compound.

13. The method according to claim 1, wherein the aliphatic amine compound is an aliphatic diamine compound.

14. The method according to claim 13, wherein the aliphatic diamine compound is a long-chain aliphatic diamine compound.

15. The method according to claim 13, wherein the aliphatic amine compound is a saturated aliphatic diamine compound.

16. The method according to claim 14, wherein the long-chain aliphatic diamine compound is alkylpropanediamine.

17. The method according to claim 1, wherein a molar ratio between the acrylic acid monomer and the sulfonic acid monomer in the copolymer is 60 to 95:40 to 5.

18. The method according to claim 1, wherein the copolymer is 2-acrylamido-2-methylpropane sulfonic acid or 3-allyloxy-2-hydroxypropane sulfonic acid.

19. The method according to claim 2, wherein the phosphorus compound is a phosphonic acid compound.

20. The method according to claim 19 wherein the phosphonic acid compound is 2-phosphonobutane-1,2,4-tricarboxylic acid or 1-hydroxyethylidene-1,1-diphosphone acid.
